(19) United States
(12) Patent Application Publication
(10) Pub. No.: US 2025/0214810 A1
(43) Pub. Date: Jul. 3, 2025

(54) COUPLING SYSTEM FOR LIFTING A HEAVY LOAD AND A MALE PART

(71) Applicant: IQIP HOLDING B.V., Sliedrecht (NL)

(72) Inventors: Marius Peerdeman, Gorinchem (NL); Quintus Wilhelmus Petrus Maria Zuijdgeest, Zoetermeer (NL)

(21) Appl. No.: 18/851,954

(22) PCT Filed: Mar. 28, 2023
(86) PCT No.: PCT/NL2023/050154

§ 371 Date: Sep. 27, 2024

(30) Foreign Application Priority Data
Apr. 1, 2022 (NL) 2031475

(51) Int. Cl. B66C 1/66; B25J 15/00; B66C 1/54

(52) U.S. Cl. CPC B66C 1/66; B25J 15/0047; B66C 1/54

(57) ABSTRACT

A coupling system for lifting a heavy load comprises a male part lockable to a female. The male part has a frame, a locking pin longitudinally movable with respect to the frame in a locking direction and a plurality of latches, which are movably connected to the frame and arranged around the longitudinal axis of the locking pin. An outer side of the locking pin and inner sides of the latches cooperate with each other such that upon moving the locking pin in the locking direction along the inner sides of the latches, the locking pin pushes the latches outwardly in a transverse direction of the longitudinal axis from retracted positions to extended positions of the latches. The female part has a hole surrounded by a rim, which allows the latches to penetrate into the hole in their retracted positions and behind which the latches hook in their extended positions.

### CROSS-REFERENCE TO RELATED APPLICATIONS

This Application is a Section 371 National Stage Application of International Application No. PCT/NL2023/050154, filed Mar. 28, 2023 and published as WO 2023/191618 A1 on Oct. 5, 2023, in English.

### BACKGROUND

The present invention relates to a coupling system for lifting a heavy load.

Such a coupling system is known from WO 2018/139931. The known coupling system has a male part and a female part which are lockable to each other. The male part has an attachment eye for a hoisting cable of a crane and the female part is part of a heavy load to be hoisted by the crane. The male part has a circle cylindrical main body which comprises a plurality of latches that are evenly distributed over the circumference of the main body. The latches are pivotable about axes extending horizontally and tangentially through their lower ends which enable the latches to deflect inwards when the male part is inserted into a hole of the female part. When the male part has been inserted into the hole of the female part the latches are moved outwardly in order to hook behind a rim around the hole of the female part. Hydraulic actuators are located inside the main body to actively move the latches in order to lock and unlock the male part and the female part with respect to each other. Because of the presence of the hydraulic actuators the dimensions of the male part of the known coupling system are relatively large.

### SUMMARY

A coupling system comprises a male part and a female part which are lockable to each other, wherein the male part has a frame, a locking pin which is connected to the frame and movable with respect to the frame along a longitudinal axis of the locking pin in a locking direction and a plurality of latches which are movably connected to the frame and arranged around the longitudinal axis of the locking pin, wherein an outer side of the locking pin and inner sides of the latches cooperate with each other such that upon moving the locking pin in the locking direction along the inner sides of the latches the locking pin pushes the latches outwardly in transverse direction of the longitudinal axis of the locking pin from retracted positions to extended positions of the latches, wherein the female part has a hole surrounded by a rim which allows the latches to penetrate into the hole in their retracted positions and behind which the latches hook in their extended positions so as to lock the male part and the female part to each other.

An advantage of the coupling system is that the single locking pin moves the plurality of latches from their retracted positions to their extended positions which provides a relatively compact coupling system. When the latches are hooked behind the rim the male part and the female part are locked with respect to each other in a direction along the longitudinal axis of the locking pin, whereas the locking pin supports the latches such that the latches cannot return to their retracted positions.

At least a portion of the outer side of the locking pin may be circle cylindrical, whereas the distances between the inner sides of the latches and the longitudinal axis of the locking pin may be equal.

The latches may be distributed evenly about the longitudinal axis of the locking pin. At least in the extended positions of the latches they surround the locking pin such that their inner sides face the outer side of the locking pin. It is possible that the latches also surround the locking pin in their retracted positions.

In a practical embodiment each of the latches has a locking surface which contacts a bearing surfaces of the female part next to the rim when the male part and the female part are locked to each other, which locking surface is angled with respect to the longitudinal axis of the locking pin. The locking surface may be perpendicular to the longitudinal axis of the locking pin, but it may also be tapered in axial direction of the locking pin.

The locking surface may be directed opposite to the locking direction of the locking pin.

In an embodiment each of the latches is tiltable with respect to the frame about an axis of rotation which is angled with respect to the longitudinal axis of the locking pin and extending remote from the locking surface.

Each of the latches may have a concave contact surface which is supported by a fulcrum of the frame, enabling the latches to tilt with respect to the frame. The fulcrum and the concave contact surface may be shaped such that the axis of rotation slightly moves during a tilting movement of the latch.

In a particular embodiment the fulcrums are formed by an annular protrusion at the frame. In this case the respective axes of rotation may be tangential to the annular protrusion.

The locking surfaces of the latches may be located beyond the corresponding axes of rotation as seen in the locking direction of the locking pin.

In a preferred embodiment the outer side of the locking pin and the inner sides of the latches are adapted such that upon moving the locking pin in an unlocking direction, which is opposite to the locking direction, the locking pin forces the latches from their extended positions to their retracted positions, since this allows the latches to pass the rim of the hole of the female part so as to decouple the coupling system after a hoisting action.

In the retracted positions of the latches the locking pin may contact each of the latches at a location which lies beyond the axis of rotation as seen from the locking surface to the axis of rotation. This means that the locking pin can tilt the latches such that they return from their extended positions to their retracted positions. In fact, the latches are formed as rocker arms or levers.

In an embodiment one of the outer side of the locking pin and the inner sides of the respective latches have projections which fit in cooperating grooves in the other one of the outer side of the locking pin and the inner sides of the respective latches, wherein each of the grooves has a decreasing depth in axial direction of the locking pin such that the projections and the grooves are forced to move in outward direction from each other when the locking pin moves in the unlocking direction. For example, if the inner sides of the respective latches have projections which fit in cooperating grooves in the outer side of the locking pin the projections will be forced in outward direction of the grooves when the locking pin moves in the unlocking direction such that the latches are tilted and return from their extended positions to their retracted positions.

The frame may be provided with a linear actuator for moving the locking pin, for example a hydraulic cylinder.

The invention is also related to a male part for a coupling system as described hereinbefore, comprising a frame, a locking pin which is connected to the frame and movable with respect to the frame along a longitudinal axis of the locking pin in a locking direction and a plurality of latches, which are movably connected to the frame and arranged around the longitudinal axis of the locking pin, wherein an outer side of the locking pin and inner sides of the latches cooperate with each other such that upon moving the locking pin in the locking direction along the inner sides of the latches the locking pin pushes the latches outwardly in transverse direction of the longitudinal axis of the locking pin from retracted positions to extended positions of the latches. The male part may be fixed to a cable of a crane and used to couple to a female part which is part of a heavy load, for example a nacelle of a wind turbine or the like.

In an embodiment each of the latches has a locking surface for contacting a bearing surface of the female part, which locking surface is angled with respect to the longitudinal axis of the locking pin.

Each of the latches may be tiltable with respect to the frame about an axis of rotation which is angled with respect to the longitudinal axis of the locking pin and extending remote from the locking surface.

In an embodiment the locking surfaces of the latches are located beyond the corresponding axes of rotation as seen in the locking direction of the locking pin.

The locking surface may be directed opposite to the locking direction of the locking pin.

In an embodiment the outer side of the locking pin and the inner sides of the latches are adapted such that upon moving the locking pin in an unlocking direction, which is opposite to the locking direction, the locking pin forces the latches from their extended positions to their retracted positions.

In the retracted positions of the latches the locking pin may contact each of the latches at a location which lies beyond the axis of rotation as seen from the locking surface to the axis of rotation.

In an embodiment one of the outer side of the locking pin and the inner sides of the respective latches have projections which fit in cooperating grooves in the other one of the outer side of the locking pin and the inner sides of the respective latches, wherein each of the grooves has a decreasing depth in axial direction of the locking pin such that the projections and the grooves are forced to move in outward direction from each other when the locking pin moves in the unlocking direction.

The invention will hereafter be elucidated with reference to the schematic drawings showing an embodiment of the invention by way of example.

### BRIEF DESCRIPTION OF THE DRAWINGS

FIG. 1 is a perspective sectional view of a coupling system.

FIGS. 2 and 3 are sectional views of the embodiment as shown in FIG. 1, showing the coupling system in an unlocked condition.

FIG. 4 is a similar view as FIGS. 2 and 3, but showing the coupling system in a locked condition.

FIG. 5 is an enlarged sectional view along the line V-V in FIG. 3.

FIG. 6 is an enlarged sectional view along the line VI-VI in FIG. 4.

### DETAILED DESCRIPTION OF THE ILLUSTRATIVE EMBODIMENTS

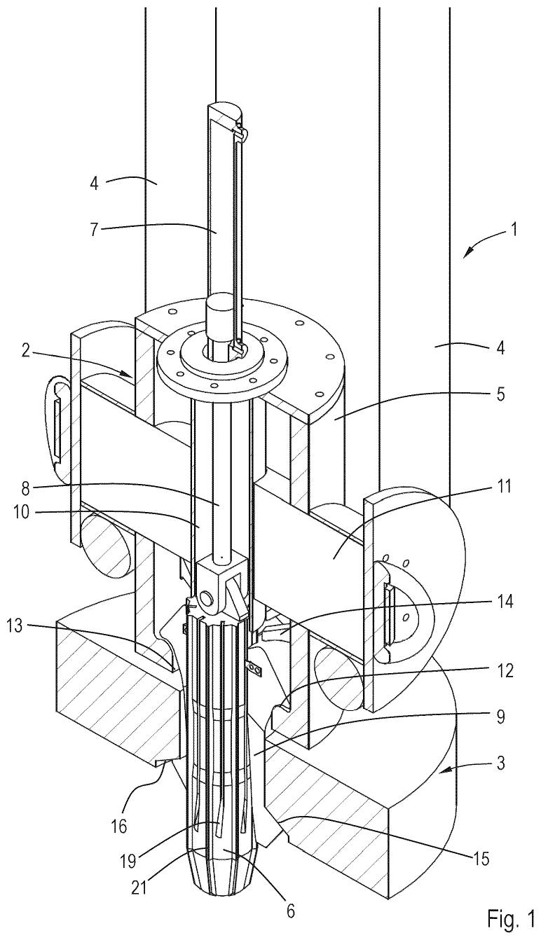

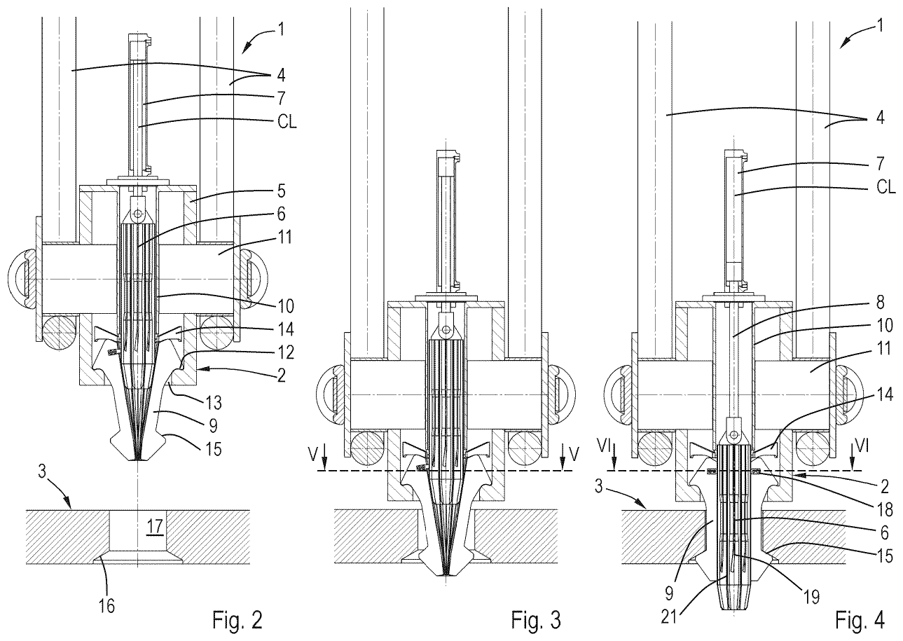

FIGS. 1-6 show an embodiment of a coupling system 1. The coupling system 1 is intended for lifting a heavy load. It comprises a male part 2 and a female part 3 which are lockable to each other. The male part 2 is supported by slings 4 which hang from a crane (not shown) and the female part 3 is part of a heavy load (not shown), for example a nacelle of a wind turbine which is lifted by the crane. FIGS. 2-4 illustrate successive steps of locking the male part 2 and the female part 3 to each other.

The male part 2 has a tubular frame 5, which is also called a bucket, a locking pin 6, a hydraulic cylinder 7 including a piston rod 8 and a plurality of latches 9. The locking pin 6 is located inside the frame 5 and slidable with respect to a cylindrical locking pin guide 10 along a centreline CL of the locking pin 6. The locking pin guide 10 is fixed inside the frame 5. The piston rod 8 of the hydraulic cylinder 7 is coupled to the locking pin 6 such that it can move the locking pin 6 up and down with respect to the frame 5. FIG. 1 shows that a hoisting pin 11 extends through the frame 2 in a direction which is perpendicular to the centreline CL of the locking pin 6. The hoisting pin 11 forms projections at opposite sides of the frame 5, about which projections the respective slings 4 engage.

The locking pin 6 has a circle cylindrical shape and a tapered free end portion, which converges towards a free end of the locking pin 6. The latches 9 are arranged around the locking pin 6. They are mounted to the frame 5 and tiltable with respect to the frame 5 about respective fulcrums. In this case the fulcrums are formed by an annular protrusion 12 around a circular through-hole 13 in a bottom of the frame 5. Concave contact surfaces of the respective latches 9 rest on the annular protrusion 12, hence creating respective axes of rotation about which the latches 9 tilt. The axes of rotation extend tangentially at the annular protrusion 12. It is noted that the annular protrusion 12 and the concave contact surfaces of the respective latches 9 are shaped such that the latches 9 also slightly slide over the annular protrusion 12 during their tilting movement. This means that their axes of rotation will also slightly shift when the latches 9 are tilted. In the embodiment as shown in the figures the male part 2 has eight latches 9, but the number may be different in an alternative embodiment.

The frame 5 is further provided with latch guides 14 along which upper sides of the respective latches 9 slide during their tilting movements. The latch guides 14 protrude from an inner wall of the frame 5 and are directed to the locking pin 6.

Each of the latches 9 is provided with a locking surface 15 which is angled with respect to the centreline CL of the locking pin 6. FIGS. 1, 4 and 6 show a locked condition of the coupling system 1 in which the locking surfaces 15 engage a bearing surface 16 of the female part 3 which extends around a rim of a hole 17 in the female part 3. The bearing surface 16 is tapered in axial direction of the locking pin 6, but it may be perpendicular to the longitudinal axis of the locking pin 6 in an alternative embodiment. The locking surfaces 15 may be shaped accordingly in order to create appropriate contacts when the male part 2 and the female part 3 are coupled to each other.

An outer side of the locking pin 6 and inner sides of the latches 9 which are directed to the centerline CL of the locking pin 6 are adapted such that upon moving the locking pin 6 in a locking direction along the inner sides of the latches 9 the locking pin 6 pushes against the latches 9 and tilts them from retracted positions to extended positions of the latches 9. This means that the locking surfaces 15 are moved outwardly in transverse direction of the centreline CL of the locking pin 6. In this case the locking direction is directed downwardly, i.e. in a direction from a proximal end to a distal end, i.e. the free end, of the locking pin 6. The locking surfaces 15 in the embodiment as shown are directed opposite to the locking direction of the locking pin 6. The locking surfaces 15 are located beyond the corresponding axes of rotation of the latches 9 as seen in the locking direction of the locking pin 6. When the locking pin 6 is moved upwardly with respect to the frame 5, i.e. in an unlocking direction that is opposite to the locking direction, the latches 9 are tilted such that the locking surfaces 15 move inwardly from their extended positions to their retracted positions. It is noted that the annular protrusion 12 is directed in the unlocking direction of the locking pin 6.

FIGS. 2 and 3 illustrate that the tapered end portion of the locking pin 6 allows the latches 9 to move from their extended positions to their retracted positions, whereas FIG. 4 illustrates that in the extended positions of the latches 9 a cylindrical portion of the locking pin 6 contacts the inner sides of the latches 9.

FIGS. 2-4 illustrate successive steps when the male part 2 is coupled and locked to the female part 3. FIG. 2 shows that the locking pin 6 is in its upper or retracted position with respect to the frame 5. In this condition the latches 9 are in their retracted positions. The hole 17 of the female part 3 is adapted such that it allows portions of the latches 9 which comprise the locking surfaces 15 to penetrate into the hole 17, which is illustrated in FIG. 3. It can be seen that in this condition the locking pin 6 is still in its retracted position with respect to the frame 5. After the frame 5 reaches a predetermined position above the female part 3 the hydraulic cylinder 7 is operated such that piston rod 8 pushes the locking pin 6 in the locking direction, which is shown in FIG. 4. Consequently, the latches 9 are tilted such that the locking surfaces 15 contact the bearing surface 16, i.e. the latches 9 hook behind the rim of the hole 17. As a result, the male part 2 and the female part 3 are locked to each other and the crane may hoist the load that is fixed to the female part 3,

In order to unlock the male part 2 and the female part 3 from each other the locking pin 6 is moved from its lower position to its upper position by the hydraulic cylinder 7. Consequently, the latches 9 are tilted back from their extended positions to their retracted positions which is explained hereinafter. This allows the portions of the latches 9 which comprise the locking surfaces 15 to pass the hole 17 of the female part 3 such that the male part 2 can be lifted with respect to the female part 3.

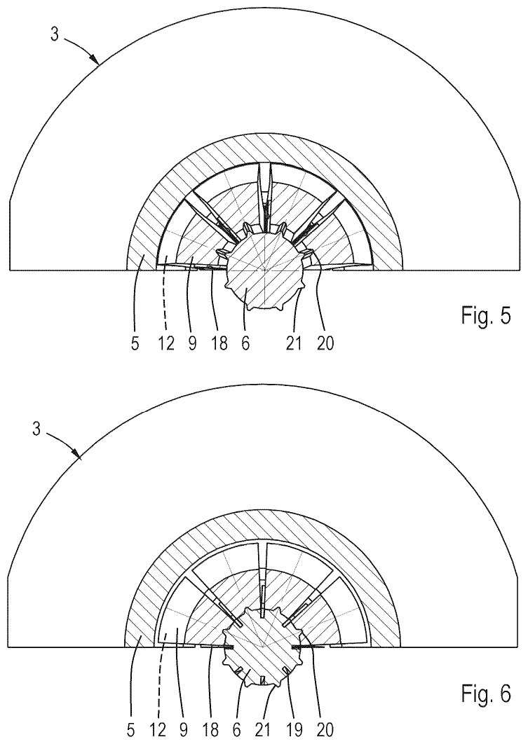

Referring to FIGS. 5 and 6, each of the latches 9 is provided with a latch projection 18 which projects from its inner side to the locking pin 6 and which fits in a cooperating pin groove 19 in the locking pin 6. The pin grooves 19 extend from the proximal end towards the distal end of the locking pin 6 and they end at a distance from the tapered end portion of the locking pin 6. At a lower end portion of each pin groove 19 its depth decreases in a direction from the proximal end to the distal end of the locking pin 6. This means that when the locking pin 6 is moved in the unlocking direction the latch projections 18 are forced in outward direction of the pin grooves 19 such that the latches 9 are tilted back from their extended positions to their retracted positions. FIGS. 2-4 show that the pin grooves 19 at their lower end portions are inclined with respect to the centerline CL of the locking pin 6 in circumferential direction of the locking pin 6. This is due to the fact that the latch projections 18 are located at outer sides of the respective latches 9 in circumferential direction about the locking pin 6, i.e. eccentrically with respect to planes that extend perpendicularly to the respective axes of rotation of the latches 9 on the annular protrusion 12.

FIGS. 5 and 6 show that the inner side of each of the latches 9 is provided with a latch groove 20 in which a cooperating pin ridge 21 of the locking pin 6 fits. The pin ridges 21 extend from the proximal end to the distal end of the locking pin 6 such that they fit in the corresponding latch grooves 20 in both the retracted condition and the extended condition of the locking pin 6. This prevents the latches 9 from moving with respect to the locking pin 6 in circumferential direction thereof. When the locking pin 6 moves along its centerline CL in the locking direction or the unlocking direction the pin ridges 21 slide within the latch grooves 20.

The invention is not limited to the embodiments shown in the drawings and described hereinbefore, which may be varied in different manners within the scope of the claims and their technical equivalents. For example, the latches may be translated in transverse direction of the locking pin or they may be flexible in order to move the locking surfaces between the retracted and extend positions or they may be pivotally mounted to the frame through respective pivots including fixed axes of rotation. Furthermore, the outer side of the locking pin and the inner sides of the latches may have alternative shapes which still allow a similar tilting movement of the latches.

1. A coupling system for lifting a heavy load, comprising a male part and a female part which are lockable to each other, wherein the male part has a frame, a locking pin which is connected to the frame and movable with respect to the frame along a longitudinal axis of the locking pin in a locking direction and a plurality of latches wherein latches thereof are movably connected to the frame and arranged around the longitudinal axis of the locking pin, wherein an outer side of the locking pin and inner sides of the latches cooperate with each other such that upon moving the locking pin in the locking direction along the inner sides of the latches, the locking pin pushes the latches outwardly in a transverse direction of the longitudinal axis of the locking pin from retracted positions to extended positions of the latches, wherein the female part has a hole surrounded by a rim which allows the latches to penetrate into the hole in their retracted positions and behind which the latches hook in their extended positions so as to lock the male part and the female part to each other.

2. The coupling system according to claim 1, wherein the latches are distributed evenly about the longitudinal axis of the locking pin.

3. The coupling system according to claim 1, wherein each of the latches has a locking surface which contacts a bearing surface of the female part next to the rim when the male part and the female part are locked to each other, which locking surface is angled with respect to the longitudinal axis of the locking pin.

4. The coupling system according to claim 3, wherein the locking surface is directed opposite to the locking direction of the locking pin.

5. The coupling system according to claim 3, wherein each of the latches is tiltable with respect to the frame about an axis of rotation which is angled with respect to the longitudinal axis of the locking pin and extending remote from the locking surface.

6. The coupling system according to claim 5, wherein each of the latches has a concave contact surface which is supported by a fulcrum of the frame, enabling the latches to tilt with respect to the frame.

7. The coupling system according to claim 6, wherein the fulcrums are formed by an annular protrusion at the frame.

8. The coupling system according to claim 5, wherein the locking surfaces of the latches are located beyond the corresponding axes of rotation as seen in the locking direction of the locking pin.

9. The coupling system according to claim 5, wherein the outer side of the locking pin and the inner sides of the latches are configured such that upon moving the locking pin in an unlocking direction, which is opposite to the locking direction, the locking pin forces the latches from their extended positions to their retracted positions.

10. The coupling system according to claim 9, wherein in the retracted positions of the latches the locking pin contacts each of the latches at a location which lies beyond the axis of rotation as seen from the locking surface to the axis of rotation.

11. The coupling system according to claim 10, wherein one of the outer side of the locking pin and the inner sides of the respective latches have projections which fit in cooperating grooves in the other one of the outer side of the locking pin and the inner sides of the respective latches, wherein each of the grooves has a decreasing depth in axial direction of the locking pin such that the projections and the grooves are forced to move in outward direction from each other when the locking pin moves in the unlocking direction.

12. The coupling system according to claim 1, wherein the frame is provided with a linear actuator for moving the locking pin, for example a hydraulic cylinder.

13. The male part for a coupling system according to claim 1, comprising a frame, a locking pin which is connected to the frame and movable with respect to the frame along a longitudinal axis of the locking pin in a locking direction and a plurality of latches, which are movably connected to the frame and arranged around the longitudinal axis of the locking pin, wherein an outer side of the locking pin and inner sides of the latches cooperate with each other such that upon moving the locking pin in the locking direction along the inner sides of the latches the locking pin pushes the latches outwardly in transverse direction of the longitudinal axis of the locking pin from retracted positions to extended positions of the latches.

14. The male part according to claim 13, wherein each of the latches has a locking surface for contacting a bearing surface of the female part, which locking surface is angled with respect to the longitudinal axis of the locking pin.

15. The male part according to claim 14, wherein each of the latches is tiltable with respect to the frame about an axis of rotation which is angled with respect to the longitudinal axis of the locking pin and extending remote from the locking surface.

16. The male part according to claim 15, wherein the locking surfaces of the latches are located beyond the corresponding axes of rotation as seen in the locking direction of the locking pin, wherein the locking surface may be directed opposite to the locking direction of the locking pin.

17. The male part according to claim 14, wherein the outer side of the locking pin and the inner sides of the latches are configured such that upon moving the locking pin in an unlocking direction, which is opposite to the locking direction, the locking pin forces the latches from their extended positions to their retracted positions.

18. The male part according to claim 17, wherein in the retracted positions of the latches the locking pin contacts each of the latches at a location which lies beyond the axis of rotation as seen from the locking surface to the axis of rotation.

19. The male part according to claim 18, wherein one of the outer side of the locking pin and the inner sides of the respective latches have projections which fit in cooperating grooves in the other one of the outer side of the locking pin and the inner sides of the respective latches, wherein each of the grooves has a decreasing depth in axial direction of the locking pin such that the projections and the grooves are forced to move in outward direction from each other when the locking pin moves in the unlocking direction.
